(19) United States
(12) Patent Application Publication
(10) Pub. No.: US 2005/0180841 A1
(43) Pub. Date: Aug. 18, 2005

(54) Bund nuts

(76) Inventor: Tian-Fu Cao, Kaohsiung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/776,206

(22) Filed: Feb. 12, 2004

(51) Int. Cl. F16B 19/08

(52) U.S. Cl. 411/501

(57) ABSTRACT

A bund nut includes a duct having a latch section formed on the peripheral surface and a flange extending from the periphery. The duct has a first area and a second area joining at a juncture to form an annular ring. The annular ring has a ring surface inclined from the wall of the second area to the wall of the first area. During the bund nut is undergoing riveted process coupling objects, the pulling force concentrates on the peripheral surface of the duct. Thus applying a minimum force can bend the duct quickly to enable the flange and the bending section of the duct to tightly clamp and couple the objects.

### BACKGROUND OF THE INVENTION

1. Field of the Invention

This invention relates to a bund nut, more particularly to a bund nut for reducing pulling force to achieve fast bending and clamp objects as desired.

2. Description of the Related Art

Bund nut has a wide range of applications and usually is employed to rivet one object with another. The riveted operation of the bund nut generally is accomplished through a bund nut gun. As the bund nut gun forms not part of the invention, details of its structure are omitted herein.

Referring to FIGS. 1 and 2, a conventional bund nut 1 includes a duct 11 and a flange 12 extending outwards from the periphery thereof. The interior of the duct 11 has a first area 13 and a second area 14 that are adjacent to each other. The first area 13 is close to the flange 12 and forms a greater space than the second area 14. The second area 14 has a peripheral wall 141 which has screw threads 142 formed thereon. The duct 11 has a peripheral surface 111 corresponding to the first area 13 and forming a latch section 15. The latch section 15 has a plurality of spaced ribs 151.

Referring to FIG. 2, when the bund nut 1 is used, the riveted objects 2 (two sets are shown in the drawings) are formed with an opening 21 at a size same as the outside diameter of the bund nut 1. The bund nut 1 is inserted into the opening 21 with the bottom side of the flange 12 in contact with the surface of the object 2. Then a bund nut gun is disposed into the bund nut to couple with the screw threads 142 on the wall 141 of the second area 14. Then the bund nut 1 is pulled by the bund nut gun and compressed, the force is initially distributed evenly on the bund nut 1. At the final stage, the force concentrates on one point of the bund nut 1 and the bund nut 1 is bent and deformed to form a bending section 112 to clamp and hold the riveted objects 2 with the flange 12.

While the conventional bund nut 1 mentioned above can clamp the objects tightly, it still has drawbacks to be improved, notably:

1. The Bending of the duct 11 requires a great force and is performed at a low speed:

As the duct 11 has the first area 13 and the second area 14, and the wall 141 of the second area 14 is thicker than that of the first area 13, and the peripheral surface corresponding to the first area 13 has the latch section 15, and the first and second areas 13 and 14 are vertical, to bend the duct 11 to form the bending section 112, the bund nut gun has to generate a pulling force greater than the maximum stress limit of the duct 11 so that the duct 11 may be bent at the weakest portion to form the bending section 112 to clamp the objects 2 with the flange 12. To do this, the operation pulling force produced by users has to overcome the maximum bearable stress when the duct 11 is in the vertical condition. In another word, to reach the vertical condition, the duct 11 bending speed will be influenced by the maximum bearable stress. This causes inconvenience in operation.

b 2. The bending effect for the duct 11 is not desirable.

As previously discussed, the duct 11 is bent when subject to a force from the bund nut gun. The location of bending section on the duct 11, besides being determined by the duct 11 subject to a force exceeding the bearable stress, also is affected by the material of the duct 11. As a result, when the duct 11 is subject to a pulling force and bends, the elevation of the bending section 112 varies due to different stresses received on the duct. Hence the bending section 112 could be skew and result in unsatisfactory riveted. And positioning of the objects 2 could be affected.

### SUMMARY OF THE INVENTION

Therefore, the object of the present invention is to provide a bund nut for reducing pulling force to achieve fast bending and clamp objects as desired.

According to this invention, it mainly includes a duct which has a latch section formed on the peripheral surface and a flange extending from the periphery. The interior of the duct has a first area and a second area that are adjacent to each other. The first area is close to the flange and forms a greater space than the second area. The second area has a peripheral wall which has screw threads formed thereon. The juncture of the first area and the second area forms an annular ring with a surface inclined from the wall of the second area to the wall of the first area. During the bund nut is undergoing the riveted process, pulling force directly concentrates on the surrounding wall surface of the duct. Thus the bending effect may be accomplished by a minimum force to achieve tightly coupling for the objects between the flange and the bending section of the duct.

### BRIEF DESCRIPTION OF THE DRAWINGS

The accompanying drawing is included to provide a further understanding of the invention, and is incorporated in and constitutes a part of this specification. The drawing illustrates an embodiment of the invention and, together with the description, serves to explain the principles of the invention. In the drawing,

FIG. 1 is a perspective view of a conventional bund nut;

FIG. 2 is a schematic view of a conventional bund nut tightly coupling objects;

FIG. 3 is a perspective view of one part structure of the bund nut according to the invention;

FIG. 4 is a schematic view of an embodiment according to the invention in use;

FIG. 5 is a schematic view of an embodiment according to the invention in a tightly coupled condition;

FIG. 6 is a schematic view of another embodiment of the bund nut according to the invention in use.

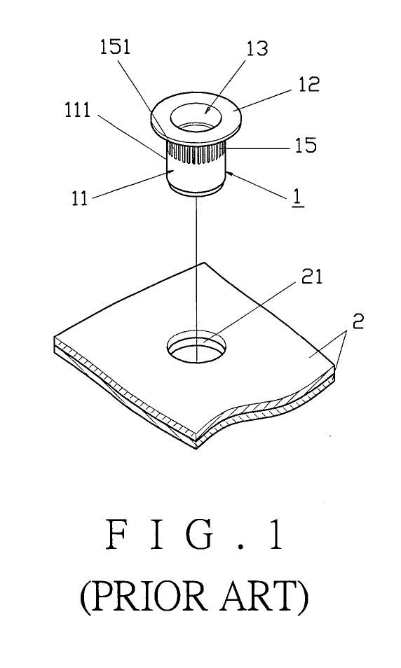

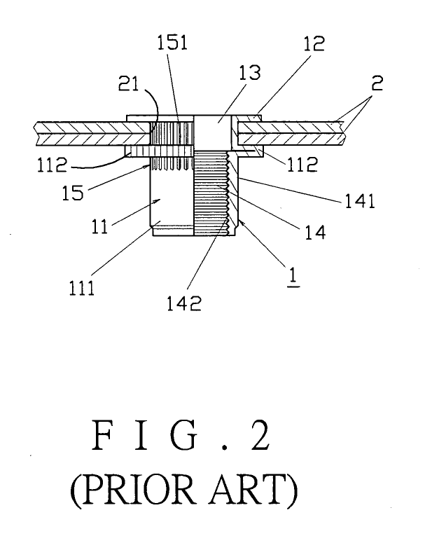

### DETAILED DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

Referring to FIG. 3, the bund nut 3 according to the invention includes a duct 31 and a flange 32 extending outwards from the periphery of one end thereof. The duct 31 has a peripheral surface 311 close to the flange forming a latch section 33. The latch section 33 has a plurality of spaced ribs 331.

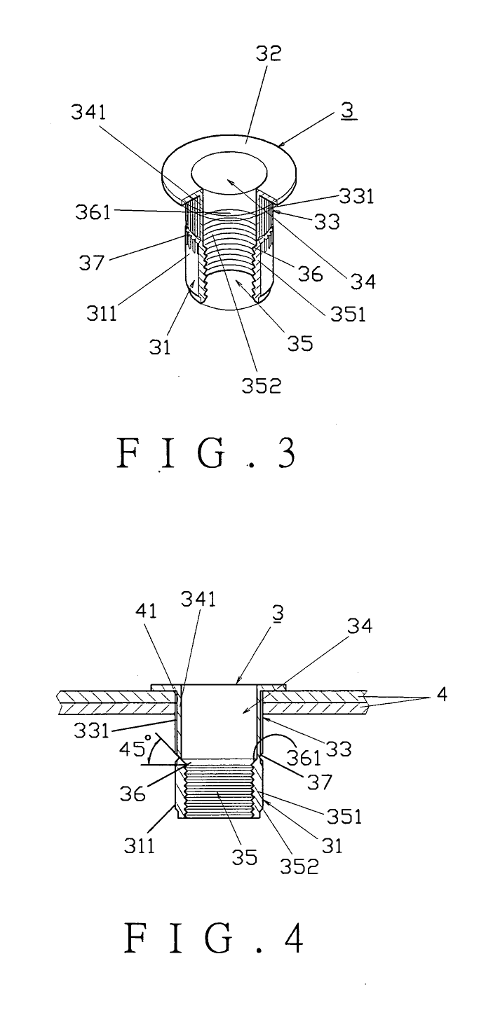

Referring to FIG. 4, the interior of the duct 31 has a first area 34 and a second area 35 that are adjacent to each other. The first area 34 is close to the flange 32 and forms a greater space than the second area 35. The second area 35 has a peripheral wall 351 which has screw threads 352 formed thereon. The juncture of the first area 34 and the second area 35 forms an annular ring 36 with a ring surface 361 inclined from the wall 351 of the second area 35 to the wall 341 of the first area 34. The inclined angle is preferably 45 degrees. The latch section 33 has an annular groove 37 located above the top side of the annular ring 36. In this embodiment, the location of the annular groove 37 corresponds to where the inclined ring surface 361 extends to the peripheral surface 311 of the duct 31.

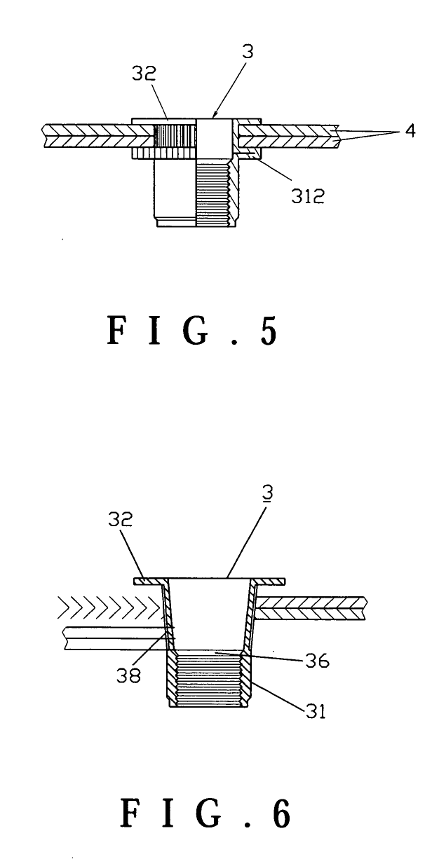

Referring to FIG. 4, when in use, first form openings 41 on the riveted objects 4 (two are shown in the drawing) that has a diameter same as the outside diameter of the bund nut 3. The bottom side of the flange 32 is in contact with the surface of the object 4. A bund nut gun (not shown in the drawing) is extended into the duct to couple with the screw threads 352 of the inner wall 351 of the second area 35. Pull the bund nut 3 through the bund nut gun to compress the bund nut 3. Due to the annular groove 37 on the duct 31, the wall where the annular groove 37 is formed is thinner. Thus the pulling force applied on the duct 31 directly concentrates on the annular groove 37. Therefore users can exert a smallest force to bend the duct 31 quickly on where the annular groove 37 is located. As the bending portion is braced by the annular ring 36, the bending portion is extended outwards to form a bending section 312 as shown in FIG. 5. Due to the annular groove 37 is preformed at the same elevation on the duct 31, the resulting bending section 312 may be formed in a better shape to enable the flange 32 and the bending section 312 to clamp the riveted objects 4 at both sides to achieve a tightly coupling effect. Skew of the bending section 312 may be prevented to avoid affecting the positioning of the riveted objects 4.

Refer to FIG. 6 for another embodiment of the invention. The bund nut 3 includes a duct 31 and a flange 32 which is extended outwards from the periphery thereof. Between the top side of the annular ring 36 and the flange 32, the peripheral surface of the duct 31 forms an inclined peripheral surface 38. When in use, it adopts the same approach as the previous embodiment. When the duct 3 is the subject to a force, the pulling force received by the duct 31 concentrates in the juncture of the inclined peripheral surface 38 and the vertical surface of the duct 31. Thus users can exert a smallest force to bend the duct 31 at the juncture quickly. Due to the juncture is located at the same elevation of the duct 31, the resulting bending section (not shown in the drawing) may be formed in a better shape to achieve a tightly coupling effect.

In summary, the bund nut according to the invention has an annular ring formed at the juncture of the first and second areas, and the annular ring has an inclined ring surface extending from the wall of the second area to the wall of the first area, and an annular groove is formed on the latch section above the top side of the annular ring, or the peripheral surface of the duct is inclined, hence applying a minimum force can cause the duct to bend quickly as desired to clamp the objects with the flange to achieve tightly coupling effect.

While the present invention has been described in connection with what is considered the most practical and preferred embodiments, it is understood that this invention is not limited to the disclosed embodiments but is intended to cover various arrangements included within the spirit and scope of the broadest interpretations and equivalent arrangements.

1. A bund nut comprising a duct and a flange extending from a periphery of the duct, the interior of the duct having a first area and a second area that are adjacent to each other, the first area being closer to the flange and forming a greater space than the second area, the second area having a peripheral wall which has screw threads formed thereon, the duct having a peripheral surface forming a latch section corresponding to the first area, the latch section having a plurality of spaced ribs;
wherein the first area and the second area join at a juncture which forms an annular ring with a ring surface inclined from the peripheral wall of the second area to a peripheral wall of the first area, the latch section having an annular groove located above a top side of the annular ring.

2. (cancelled).

3. The bund nut of claim 1, wherein the ring surface is inclined 45 degrees from the peripheral wall of the second area to the peripheral wall of the first area.

4. The bund nut of claim 1, wherein the ring surface is inclined and extended to the peripheral surface of the duct where the annular groove is located.

5. The bund nut of claim 1, wherein the duct has an inclined peripheral surface formed between the top side of the annular ring and the flange.

6. A bund nut comprising a duct and a flange extending from a periphery of the duct, the interior of the duct having a first area and a second area that are adjacent to each other, the first area being closer to the flange and forming a greater space than the second area, the second area having a peripheral wall which has screw threads formed thereon, the duct having a peripheral surface forming a latch section corresponding to the first area, the latch section having a plurality of spaced ribs, and
wherein the first area and the second area join at a juncture which forms an annular ring with a ring surface inclined from the peripheral wall of the second area to a peripheral wall of the first area, the latch section having an annular groove located above a top side of the annular ring, an inclined peripheral surface formed in inner and outer peripheries of the duct between the top side of the annular ring and the flange.

7. The bund nut of claim 6, wherein the ring surface is inclined 45 degrees from the peripheral wall of the second area to the peripheral wall of the first area.

8. The bund nut of claim 6, wherein the ring surface is inclined and extended to the peripheral surface of the duct where the annular groove is located.
